(19) United States
(12) Patent Application Publication
(10) Pub. No.: US 2021/0211533 A1
(43) Pub. Date: Jul. 8, 2021

(54) MONEY CLIP, HOLDER AND STAND ACCESSORY FOR A MOBILE DEVICE

(71) Applicant: ZAGG Intellectual Property Holding Co., Inc., Midvale, UT (US)

(72) Inventors: Alastair Guy Linden Kingsland, Norwich (GB); Charles Pierre Colquhoun, London (GB)

(21) Appl. No.: 17/141,525

(22) Filed: Jan. 5, 2021

Related U.S. Application Data
(60) Provisional application No. 62/957,394, filed on Jan. 6, 2020.

(51) Int. Cl. H04M 1/21; H04M 1/04

(52) U.S. Cl. CPC H04M 1/21; H04M 1/04

(57) ABSTRACT

A combined money clip, holder and stand accessory is affixable to the back of a mobile device, such as a cell phone, and has an elastic strap to receive a flat item, such as cash, and a user's finger to facilitate holding the mobile device. A trifold panel lays flat between the elastic strap and the mobile device, and is displaceable into a stand configuration to hold the mobile device at an acute angle on a support surface, and in which three panels are oriented transverse to one another and held by the elastic strap. A sleeve is coupled to a base to form a pocket.

### PRIORITY CLAIM

Priority is claimed to U.S. Provisional Patent Application Ser. No. 62/957,394, filed Jan. 6, 2020, which is hereby incorporated herein by reference.

### BACKGROUND

Mobile devices, such as cell phones, have become a ubiquitous aspect of life. Cell phones increasingly provide features to replace many aspects of modern life, including communication, entertainment, payment, social connection, etc. Certain aspects of life have proven resistant to cell phone integration, including cash, identification or driver's license, physical keys, etc. At the same time, cellular phones have become more expensive, and are prone to damage from difficulties in handling. The improvement of cell phones is an ongoing endeavor.

### BRIEF DESCRIPTION OF THE DRAWINGS

Features and advantages of the invention will be apparent from the detailed description which follows, taken in conjunction with the accompanying drawings, which together illustrate, by way of example, features of the invention; and, wherein:

FIG. 1 is a perspective view of the accessory device in accordance with an embodiment of the invention, shown with an elastic strap in a clip and closed configuration, and shown with a trifold panel in a flat and closed configuration.

FIG. 2 is a front view of the accessory device of FIG. 1.

FIG. 3 is a side view of the accessory device of FIG. 1.

FIG. 4 is an end view of the accessory device of FIG. 1

FIG. 5 is an exploded perspective view of the accessory device of FIG. 1.

FIG. 6 is a perspective view of the accessory device of FIG. 1, shown with the trifold panel in an open configuration.

FIG. 7 is a front view of the accessory device of FIG. 1.

FIG. 8 is an end view of the accessory device of FIG. 1.

FIG. 9 is an end view of the accessory device of FIG. 1, shown with the trifold panel in the stand configuration.

FIG. 10 is an end view of the accessory device of FIG. 1, shown with the trifold panel in the stand configuration.

FIG. 11 is an end view of the accessory device of FIG. 1, shown with the trifold panel in the stand configuration.

Reference will now be made to the exemplary embodiments illustrated, and specific language will be used herein to describe the same. It will nevertheless be understood that no limitation of the scope of the invention is thereby intended.

### DETAILED DESCRIPTION

Before invention embodiments are disclosed and described, it is to be understood that no limitation to the particular structures, process steps, or materials disclosed herein is intended, but also includes equivalents thereof as would be recognized by those ordinarily skilled in the relevant arts. It should also be understood that terminology employed herein is used for the purpose of describing particular examples only and is not intended to be limiting. The same reference numerals in different drawings represent the same element. Numbers provided in flow charts and processes are provided for clarity in illustrating steps and operations and do not necessarily indicate a particular order or sequence. Unless defined otherwise, all technical and scientific terms used herein have the same meaning as commonly understood by one of ordinary skill in the art to which this disclosure belongs.

As used in this specification and the appended claims, the singular forms “an” and “the” include plural referents unless the context clearly dictates otherwise. Thus, for example, reference to “a layer” includes a plurality of such layers.

In this disclosure, “comprises,” “comprising,” “containing” and “having” and the like can have the meaning ascribed to them in U.S. Patent law and can mean “includes,” “including,” and the like, and are generally interpreted to be open ended terms. The terms “consisting of” or “consists of” are closed terms, and include only the components, structures, steps, or the like specifically listed in conjunction with such terms, as well as that which is in accordance with U.S. Patent law. “Consisting essentially of” or “consists essentially of” have the meaning generally ascribed to them by U.S. Patent law. In particular, such terms are generally closed terms, with the exception of allowing inclusion of additional items, materials, components, steps, or elements, that do not materially affect the basic and novel characteristics or function of the item(s) used in connection therewith. For example, trace elements present in a composition, but not affecting the composition's nature or characteristics would be permissible if present under the “consisting essentially of” language, even though not expressly recited in a list of items following such terminology. When using an open ended term in the specification, like “comprising” or “including,” it is understood that direct support should be afforded also to “consisting essentially of” language as well as “consisting of” language as if stated explicitly and vice versa.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments described herein are, for example, capable of operation in other orientations than those illustrated or otherwise described herein. The term “coupled,” as used herein, is defined as directly or indirectly connected in an electrical or nonelectrical manner. Objects described herein as being “adjacent to” each other may be in physical contact with each other, in close proximity to each other, or in the same general region or area as each other, as appropriate for the context in which the phrase is used. Occurrences of the phrase “in one embodiment,” or “in one aspect,” herein do not necessarily all refer to the same embodiment or aspect.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, the term “about” is used to provide flexibility to a numerical range endpoint by providing that a given value may be “a little above” or “a little below” the endpoint. It is understood that express support is intended for exact numerical values in this specification, even when the term “about” is used in connection therewith.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, sizes, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 2, 3, 4, and 5, individually.

This same principle applies to ranges reciting only one numerical value as a minimum or a maximum. Furthermore, such an interpretation should apply regardless of the breadth of the range or the characteristics being described.

The terms “mobile device” and “cell phone” are used interchangeably herein, unless otherwise specified, to refer to a portable handheld electronic device, such as a cellular or cell phone, smart phone, tablet or tablet computer, phablet, game, and the like, with a display screen, and that is portable and handheld. The display screen can be a touch screen that can receive input by touch such as finger swipes, and/or can have a virtual keyboard. The mobile device can have a battery and memory and a processor with software running thereon. The mobile device can have cellular, WiFi and/or Bluetooth connectivity, and can have a wireless transmitter, receiver, or transceiver. Thus, the mobile device can provide internet browsing, game playing, movie and picture display, e-book display, etc. In addition, the mobile device can include a digital camera. Throughout the description, the term “cell phone” will be used as an example of the mobile device, and such use of the term “cell phone” includes all mobile devices or portable handheld electronic devices, unless otherwise specified.

In addition, the terms “cell phone” or “cellular phone” include any protective or decorative case or skin or film attached to the cellular phone. For example, the phrase “attached to a cellular phone” is intended to mean directly attached to the cellular phone, as well as indirectly attached by way of being attached to a protective or decorative case, skin or film.

Reference throughout this specification to “an example” means that a particular feature, structure, or characteristic described in connection with the example is included in at least one embodiment. Thus, appearances of the phrases “in an example” in various places throughout this specification are not necessarily all referring to the same embodiment.

Furthermore, the described features, structures, or characteristics may be combined in any suitable manner in one or more embodiments. In this description, numerous specific details are provided, such as examples of layouts, distances, network examples, etc. One skilled in the relevant art will recognize, however, that many variations are possible without one or more of the specific details, or with other methods, components, layouts, measurements, etc. In other instances, well-known structures, materials, or operations are not shown or described in detail but are considered well within the scope of the disclosure.

### EXAMPLE EMBODIMENTS

An initial overview of technology embodiments is provided below and specific technology embodiments are then described in further detail. This initial summary is intended to aid readers in understanding the technology more quickly but is not intended to identify key or essential features of the technology nor is it intended to limit the scope of the claimed subject matter.

The invention presents a combined money clip, holder and stand accessory that is affixable to the back of a mobile device, such as a cell phone, and has an elastic strap to receive a flat item, such as cash, and a user's finger to facilitate holding the mobile device. A trifold panel lays flat between the elastic strap and the mobile device, and is displaceable into a stand configuration to hold the mobile device at an acute angle on a support surface, and in which three panels are oriented transverse to one another and held by the elastic strap. In addition, a pocket can also receive flat items.

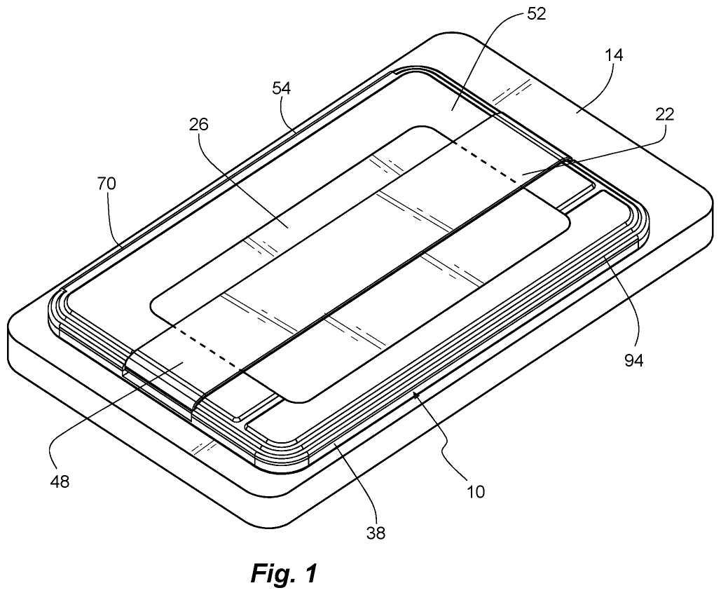

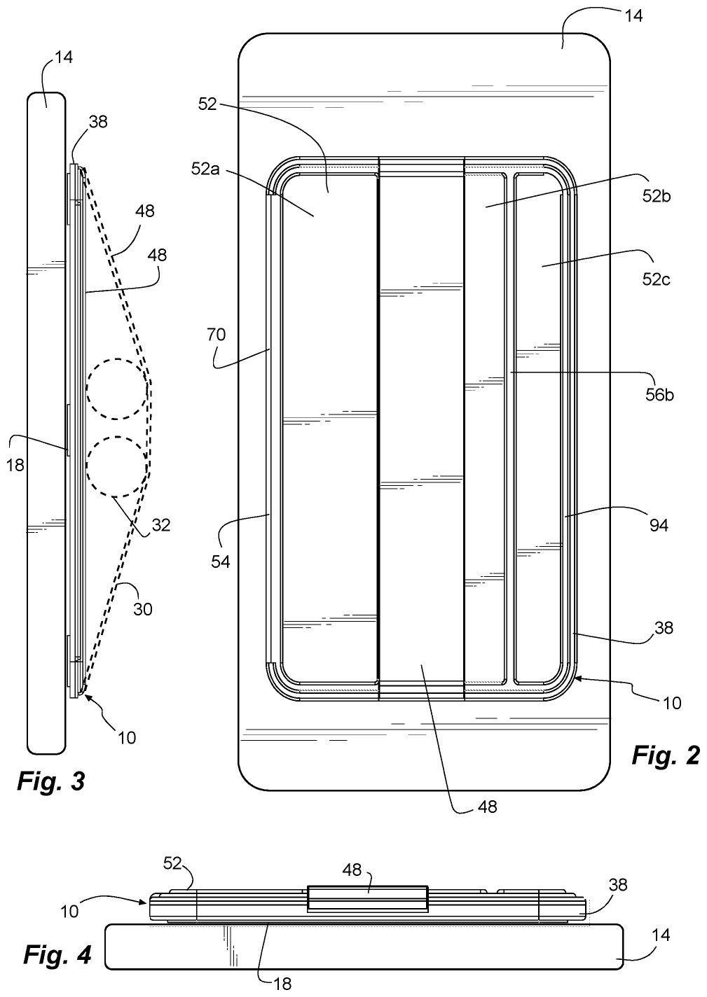

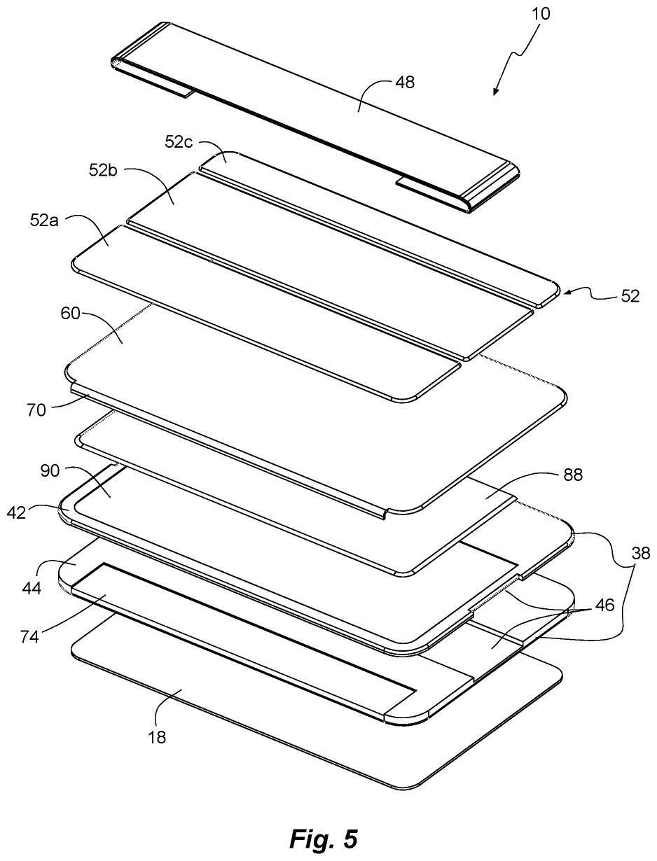

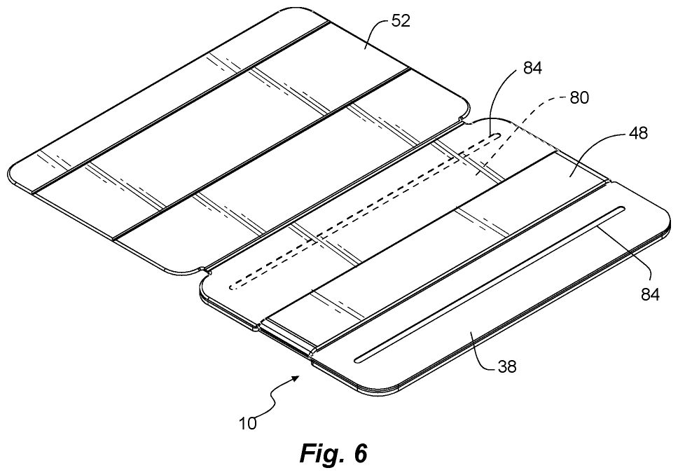

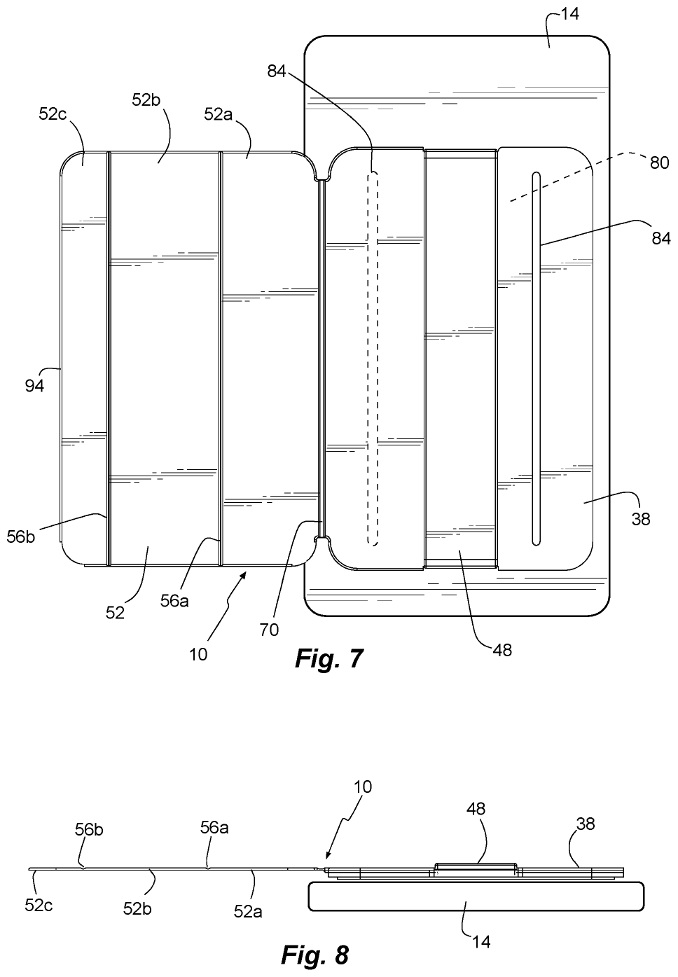

Referring to FIGS. 1-11, an example of a mobile device accessory, namely a combined money clip, holder and stand accessory 10, is shown for use with a mobile device 14, such as a cell phone. The accessory 10 can be coupled to the back of the cell phone 14 either directly, or through a case or skin. The accessory 10 can comprise a nano suction tape 18 to secure the accessory 10 to the cell phone 14. The accessory 10 can also form a clip 22, or can be utilized to clip, to secure a flat item 26, such as cash, credit card, or driver's license to the cell phone 14. The accessory 10 can also form a holder 30 to receive one or more fingers 32 to facilitate holding and grasping the cell phone 14. The accessory 10 can also form a stand 34 to support and hold the cell phone 14 at an obtuse angle on a support surface to facilitate viewing.

The accessory 10 comprises a base 38 attachable to the mobile device 14. The base 38 can be rigid and flat. As described above, the base 38 can include a nano suction tape 18 or adhesive layer to secure the base 38 to the mobile device 14. The base 38 can comprise top and bottom plates 42 and 44 affixed together. Opposite indentations 46 can be formed in one or both of the plates 42 and 44 on opposite ends thereof, as described in greater detail below. In addition, a recess can be formed in the top molding 42 as described below. The base 38 and the moldings 42 and 44 can be rigid, and can be formed of plastic, such as by injection molding.

An elastic strap 48 can have opposite ends affixed to the base 38. In one aspect, the strap 48 can be narrower than the base 38 and can be substantially centered between lateral edges of the base 38. In another aspect, the strap 48 can extend across a length of the base 38 and can be held taut between the opposite ends of the base 38. The opposite ends of the strap 48 can be retained in the opposite indentations formed between the top and bottom moldings 42 and 44 on opposite sides thereof. The strap 48 can have a clip configuration and a holder configuration. In the clip configuration, the elastic strap 48 can form the clip 22 and is substantially flat and parallel with respect to the base 38 and the mobile device 14, and in which a flat item 26, such as cash, is insertable between the elastic strap 48 and the base 38. In the holder configuration, the elastic strap 48 forms the holder 30 and is stretched away from the base 38 in a concave arc with respect to the base to form a finger loop to receive at least one finger 32 of the user's hand.

A trifold panel 52 is pivotally coupled to the base 38 and at least a portion is insertable under the elastic strap 48. The trifold panel 52 can be manipulated to form the stand 34. A hinge edge 54 of the trifold panel 52 can be pivotally coupled to the base 38. The trifold panel 52 can have three substantially rigid panels, such as a proximal hinged panel 52a, a middle panel 52b and a distal free panel 52c, and a pair of flexible hinges 56a and 56b therebetween. Each rigid panel 52a, 52b and 52c is coupled to an adjacent rigid panel by a flexible hinge 56a or 56b. In one aspect, the trifold panel 52 can also comprise a folding substrate 60 that is flexible with the three rigid panels 52a, 52b and 52c spaced-apart and affixed to the folding substrate 60. The folding substrate 60 can form the pair of flexible hinges 56a and 56b. In addition, an edge of the folding substrate 60 can be affixed to the base 38 and can form a hinge 70 about which the trifold panel 52 pivots. The edge of the folding substrate 60 can be received in an edge indentation 74 formed between the top and bottom plates 42 and 44.

The trifold panel 52 can be foldable between a flat configuration and the stand configuration. In the flat configuration, the three rigid panels 52a, 52b and 52c are substantially flat and parallel and coplanar, and held against the base 38 by the strap 48. In the stand configuration, the three rigid panels 52a, 52b and 52c form the stand 34, and the rigid panels 52a, 52b and 52c are folded transverse to one another with a distal free panel 52c positioned between the elastic strap 48 and the base 38. Thus, the trifold panel 52 is held in the stand configuration, and as the stand 34, by the strap 48. In the stand configuration, the proximal hinged panel 52a and the middle panel 52b form acute angles with respect to the base 38 and the mobile device 14. The trifold panel 52 can also have an open configuration in which the proximal hinged panel 52a, the middle panel 52b and the distal free panel 52c are pivoted about the hinge edge 54 away from the strap 48.

In one aspect, the flat item 26, such as cash, can be positioned between the elastic strap 48 and the trifold panel 52. The elastic strap 48 can hold the item 26 against the trifold panel 52. Thus, the item 26 can be located outside of the trifold panel 52 for easy access. In another aspect, the flat item 26, can be positioned between the trifold panel 52 and the base 38. Thus, the item 26 can be concealed by the trifold panel 52. In another aspect, an item 26 can be positioned outside the trifold panel 52, while another item 26 can be positioned inside the trifold panel 52. Thus, one item can be positioned for easy access, while the other item is concealed.

In addition, a pocket 80 can be carried by and formed in the base 38 and can have an opening 84 to receive an item 26, such as a credit card or key, through the opening 84 and into the pocket 80. A sleeve 88 can be carried by a top of the base 38 and the top plate 42, and located between the base 38 and the elastic strap 48. The sleeve 88 can have a perimeter with three sides affixed to the base 38 and an open side to form pocket 80. The sleeve 88 can be disposed over a recess 90 in the base 38 and the top molding 42 to form the pocket 80. In one aspect, the opening 84 of the pocket 80 can be positioned to face the hinge edge of the trifold panel 52. Thus, the pocket 80 and the opening 84 can be dosed by the trifold panel 52. In another aspect, the opening 84 of the pocket 80 can be positioned to face a free edge 94 of the trifold panel 52, opposite the hinge edge of the trifold panel. Thus, the pocket 80 can be a quick access pocket.

A method for using the combined money clip, holder and stand 10 as described above comprises:
inserting a flat item 26 between the elastic strap 48 and the base 38 with the elastic strap 48 holding the flat item 26 against the base 38;
holding the mobile device 14 by inserting at least one finger between the elastic strap 48 and the base 38; and
displacing the trifold panel 52 out of flat configuration and into the stand configuration, and placing the mobile device 14 on a support surface with the trifold panel 52 holding the mobile device 14 in a tilted orientation at an obtuse angle with respect to the support surface, and with the elastic strap 48 holding the trifold panel in the stand configuration.

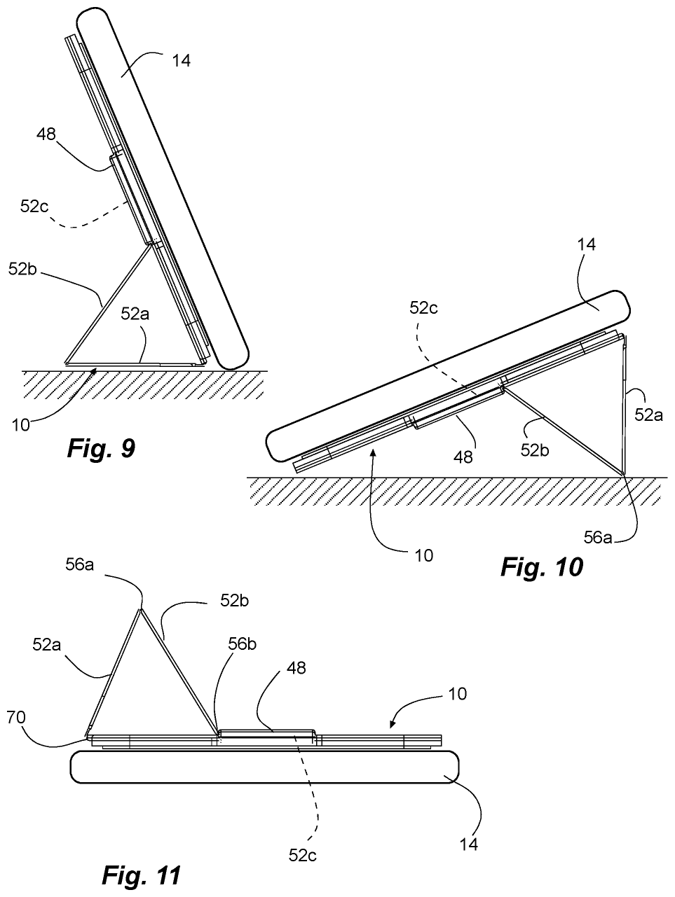

In the stand configuration, the trifold panel 58 can orient the mobile device 14 and the base 38 at a first obtuse angle with respect to a support surface, as shown in FIG. 9, with the proximal hinged panel 52a, or a first edge of the mobile device 14, or both, disposed on the support surface. Alternatively, and in addition, in the stand configuration, the trifold panel 52 can orient the mobile device 14 and the base 38 at a second obtuse and with respect to the support surface, as shown in FIG. 10, with a junction between the proximal hinged panel 52a and the middle panel 52b disposed on the support surface and the distal edge of the base 38, or a second edge of the mobile device 14, or both, disposed on the support surface.

It is to be understood that the examples set forth herein are not limited to the particular structures, process steps, or materials disclosed, but are extended to equivalents thereof as would be recognized by those ordinarily skilled in the relevant arts. It should also be understood that terminology employed herein is used for the purpose of describing particular examples only and is not intended to be limiting.

Furthermore, the described features, structures, or characteristics may be combined in any suitable manner in one or more examples. In the description, numerous specific details are provided, such as examples of lengths, widths, shapes, etc., to provide a thorough understanding of the technology being described. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the foregoing examples are illustrative of the principles of the invention in one or more particular applications, it will be apparent to those of ordinary skill in the art that numerous modifications in form, usage and details of implementation can be made without the exercise of inventive faculty, and without departing from the principles and concepts described herein. Accordingly, it is not intended that the invention be limited, except as by the claims set forth below.

What is claimed is:

1. A money clip, holder and stand accessory for a mobile device, the accessory comprising:
a) a base attachable to the mobile device;
b) an elastic strap with opposite ends affixed to opposite ends of the base, respectively, the elastic strap having:
i) a clip configuration in which elastic strap is substantially flat and parallel with respect to the base and in which a flat item is insertable between the elastic strap and the base, and
ii) a holder configuration in which the elastic strap is stretched away from the base in a concave arc with respect to the base to form a finger loop between the strap and the base; and
c) a trifold panel with a hinge edge pivotally coupled to a side of the base, a portion of the trifold panel removably insertable under the elastic strap, the trifold panel having three substantially rigid panels and a pair of flexible hinges therebetween with each rigid panel coupled to an adjacent rigid panel by a flexible hinge, the trifold panel foldable between:
i) a flat configuration in which the three rigid panels are substantially flat, parallel and coplanar and held against the base by the elastic strap, and
ii) a stand configuration in which each of the rigid panels are folded transverse to one another and a distal free panel is held between the elastic strap and the base.

2. The accessory in accordance with claim 1, wherein the trifold panel pivots about the hinge edge between:
the flat configuration in which a middle panel is positioned between the strap and the base; and
an open configuration in which a proximal hinged panel, the middle panel and the distal free panel are pivoted about the hinge edge away from the strap.

3. The accessory in accordance with claim 1, wherein the trifold panel has a proximal hinged panel and a middle panel that form acute angles with respect to the base in the stand configuration.

4. The accessory in accordance with claim 1, further comprising:
a pocket carried by the base and having an opening to receive an item through the opening and into the pocket.

5. The accessory in accordance with claim 4, wherein the opening of the pocket is positioned to face the hinge edge of the trifold panel and is closed by the trifold panel.

6. The accessory in accordance with claim 4, wherein the opening of the pocket is positioned to face a distal free edge of the trifold panel opposite the hinge edge of the trifold panel.

7. The accessory in accordance with claim 4, wherein the opening of the pocket is closed by the trifold panel in the flat configuration.

8. The accessory in accordance with claim 1, further comprising:
a sleeve carried by a top of the base and located between the base and the elastic strap, and having a perimeter with three sides affixed to the base and an open side to form a pocket.

9. The accessory in accordance with claim 1, wherein the trifold panel further comprises:
a folding substrate that is flexible and extends from the hinge edge to a distal free edge opposite the hinge edge;
three substantially rigid plates spaced-apart and affixed to the folding substrate and defining a proximal hinged panel, a middle panel, and the distal free panel;
the folding substrate forming the pair of flexible hinges between adjacent plates; and
an edge of the folding substrate affixed to the base and forming a hinge about which the trifold panel pivots with respect to the base.

10. The accessory in accordance with claim 1, wherein the strap is narrower than the base and wherein the strap is substantially centered between lateral edges of the base.

11. The accessory in accordance with claim 1, wherein the base further comprises:
a bottom plate and a top plate affixed together;
opposite indentations formed between the top and bottom plates on opposite ends thereof and receiving the opposite ends of the elastic strap; and
an edge indentation formed between the top and bottom plates and receiving the hinge edge of the trifold panel.

12. The accessory in accordance with claim 1, further comprising:
a nano suction layer on a bottom of the base configured to attach the base to the mobile device.

13. The accessory in accordance with claim 1 further in combination with a mobile device, wherein accessory further comprises:
the base attached to a back of the mobile device;
the trifold panel in the stand configuration orienting the mobile device at a first obtuse angle with respect to a support surface with a proximal hinged panel, or a first edge of the mobile device, or both, disposed on the support surface; and
the trifold panel in the stand configuration orienting the mobile device at a second obtuse and with respect to the support surface with a junction between the proximal hinged panel and a middle panel disposed on the support surface and a distal edge of the base, or a second edge of the mobile device, or both, disposed on the support surface.

14. A method for using the accessory in accordance with claim 1, the method comprising:
inserting a flat item between the elastic strap and the base with the elastic strap holding the flat item against the base;
holding the mobile device by inserting at least one finger between the elastic strap and the base; and
displacing the trifold panel out of the flat configuration and into the stand configuration, and placing the mobile device on a support surface with the trifold panel holding the mobile device in a tilted orientation at an obtuse angle with respect to the support surface, and with the elastic strap holding the trifold panel in the stand configuration.

15. A money clip, holder and stand accessory for a mobile device, comprising:
a) a base attachable to the mobile device;
b) an elastic strap with opposite ends affixed to opposite ends of the base, respectively, the elastic strap having:
i) a clip configuration in which elastic strap is substantially flat and parallel with respect to the base and in which a flat item is insertable between the elastic strap and the base, and
ii) a holder configuration in which the elastic strap is stretched away from the base in a concave arc with respect to the base to form a finger loop between the strap and the base; and
c) a trifold panel with a hinge edge pivotally coupled to the base, a portion of the trifold panel removably insertable under the elastic strap, the trifold panel having three substantially rigid panels and a pair of flexible hinges therebetween with each rigid panel coupled to an adjacent rigid panel by a flexible hinge, the panels comprising:
i) proximal hinged panel with the hinge edge,
ii) a middle panel, and
iii) a distal free panel;
d) the trifold panel being foldable between:
i) a flat configuration in which the panels are substantially flat, parallel and coplanar, and in which the middle panel is positioned between the elastic strap and the base;
ii) a stand configuration in which each of the panels are folded transverse to one another and the distal free panel is positioned between the elastic strap and the base, and the proximal hinged panel and the middle panel form acute angles with respect to the base in the stand configuration; and
iii) an open configuration in which a proximal hinged panel, the middle panel and the distal free panel are pivoted about the hinge edge away from the strap; and
e) a sleeve having a perimeter with three sides affixed to the base and an open side to form a pocket having an opening to receive an item through the opening and into the pocket.

16. The accessory in accordance with claim 15, wherein the opening of the pocket is closed by the trifold panel in the flat configuration.

17. The accessory in accordance with claim 15, wherein the base further comprises:
a bottom plate and a top plate affixed together;
opposite indentations formed between the top and bottom plates on opposite ends thereof and receiving the opposite ends of the elastic strap; and
an edge indentation formed between the top and bottom plates and receiving the hinge edge of the trifold panel.

18. The accessory in accordance with claim 15, wherein the trifold panel further comprises:
a folding substrate that is flexible and extends from the hinge edge to a distal free edge opposite the hinge edge;
three substantially rigid plates spaced-apart and affixed to the folding substrate and defining the proximal hinged panel, the middle panel, and the distal free panel;
the folding substrate forming the pair of flexible hinges between adjacent plates; and
an edge of the folding substrate affixed to the base and forming a hinge about which the trifold panel pivots with respect to the base.

19. A money clip, holder and stand accessory for a mobile device, comprising:
a) a base attachable to the mobile device, the base comprising:
i) a bottom plate and a top plate affixed together;
ii) opposite indentations formed between the top and bottom plates on opposite ends thereof; and
iii) an edge indentation formed between the top and bottom plates on a lateral side thereof;
b) an elastic strap with opposite ends received in the opposite indentations of the base, respectively, the elastic strap having:
i) a clip configuration in which elastic strap is substantially flat and parallel with respect to the base and in which a flat item is insertable between the elastic strap and the base, and
ii) a holder configuration in which the elastic strap is stretched away from the base in a concave arc with respect to the base to form a finger loop between the strap and the base;
c) a trifold panel with a hinge edge pivotally coupled to the base, a portion of the trifold panel removably insertable under the elastic strap, the trifold panel having three substantially rigid panels and a pair of flexible hinges therebetween with each rigid panel coupled to an adjacent rigid panel by a flexible hinge;
d) the three rigid panels comprising:
i) proximal hinged panel with the hinge edge,
ii) a middle panel, and
iii) a distal free panel;
e) the trifold panel comprising:
i) a folding substrate that is flexible and extends from the hinged edge to a distal free edge opposite the hinge edge;
ii) three substantially rigid plates spaced-apart and affixed to the folding substrate and defining the proximal hinged panel, the middle panel, and the distal free panel;
iii) the folding substrate forming the pair of flexible hinges between adjacent plates; and
iv) an edge of the folding substrate received in the edge indentation of the base and forming a hinge about which the trifold panel pivots with respect to the base;
f) the trifold panel being foldable between:
i) a flat configuration in which the panels are substantially flat, parallel and coplanar, and in which the middle panel is positioned between the elastic strap and the base;
ii) a stand configuration in which each of the panels are folded transverse to one another and the distal free panel is positioned between the elastic strap and the base, and the proximal hinged panel and the middle panel form acute angles with respect to the base in the stand configuration; and
iii) an open configuration in which a proximal hinged panel, the middle panel and the distal free panel are pivoted about the hinge edge away from the strap; and
e) a sleeve carried by a top of the base and located between the base and the elastic strap, and having a perimeter with three sides affixed to the base and an open side to form a pocket having an opening to receive an item through the opening and into the pocket; and
f) the opening of the pocket is closed by the trifold panel in the flat configuration.

20. The accessory in accordance with claim 19 further in combination with a mobile device, wherein accessory further comprises:
the base attached to a back of the mobile device;
the trifold panel in the stand configuration orienting the mobile device at a first obtuse angle with respect to a support surface with a proximal hinged panel, or a first edge of the mobile device, or both, disposed on the support surface; and
the trifold panel in the stand configuration orienting the mobile device at a second obtuse and with respect to the support surface with a junction between the proximal hinged panel and a middle panel disposed on the support surface and a distal edge of the base, or a second edge of the mobile device, or both, disposed on the support surface.
